(19) United States
(12) Patent Application Publication
(10) Pub. No.: US 2016/0063451 A1
(43) Pub. Date: Mar. 3, 2016

(54) Systems and Methods for Biasing Task Assistance Auto-complete Suggestions

(71) Applicant: GOOGLE INC., Mountain View, CA (US)

(72) Inventors: Vijay Umapathy, Sunnyvale, CA (US); Timothy Youngjin Sohn, Mountain View, CA (US)

(21) Appl. No.: 14/472,336

(22) Filed: Aug. 28, 2014

(51) Int. Cl. G06Q 10/10; H04L 12/24; H04L 12/58

(52) U.S. Cl. CPC G06Q 10/1097; G06Q 10/107; H04L 51/20; H04L 41/0293; H04L 51/08; H04L 51/046

(57) ABSTRACT

A method of task management executes at a computing device having one or more processors and memory. The memory stores one or more programs configured for execution by the one or more processors. The method includes receiving, from a user, a task description corresponding to an electronic message. The method further includes identifying, based on the task description, a task template from among a plurality of predefined task templates. The identified task template includes one or more task parameters. The method further includes determining values for the one or more task parameters based on contents of the electronic message. The method further includes presenting, to the user for user selection, a set of options for completing a task corresponding to the received task description. At least a first subset of the options in the set of options is based upon the one or more first task parameters.

### TECHNICAL FIELD

The disclosure relates generally to electronic messaging applications, and more specifically to providing task assistance.

### BACKGROUND

Electronic messaging applications, such as email, convey various types of information to and from a user. Some messages include a task that the user must perform. As such, many messaging applications track not only messages received by or sent by the user but also tasks that the user is to perform. Conventional methods of entering tasks (e.g., entering reminders to perform tasks) within a messaging application fail to take advantage of information that is already known about the user and therefore do not provide optimum user interfaces for task assistance.

### SUMMARY

Disclosed implementations address the above deficiencies and other problems associated with task assistance. In accordance with some implementations, a method of task assistance is executed at a computing device having one or more processors and memory storing one or more programs configured for execution by the one or more processors. The method includes receiving, from a user, a task description corresponding to an electronic message. The method further includes identifying, based on the task description, a task template from among a plurality of predefined task templates. The identified task template includes one or more first task parameters. The method further includes determining values for the one or more first task parameters based on contents of the electronic message. The method further includes presenting, to the user for user selection, a set of options for completing a task corresponding to the received task description. At least a first subset of the options in the set of options is based upon the one or more first task parameters.

In some implementations, determining values for the one or more first task parameters based on contents of the electronic message includes constructing a query using the identified task template and the values for the one or more first task parameters; and using the query to retrieve the first subset of the options in the set of options. In some implementations, the query is a parameterized universal resource locator (URL) and each determined value is used as a parameter in the URL.

In some implementations, identifying the task template based on the task description includes determining that the task template matches the task description. In some implementations, the task description is for a task that is assigned to the corresponding electronic message.

In some implementations, the electronic message and the task description are received from the user while the user is composing the electronic message. Alternatively, in some implementations, the user is a recipient of the electronic message and the task description is entered by the user in response to the user receiving the electronic message.

In some implementations, the method further comprises, receiving user selection of a first option from the set of options and completing the task according to the first option.

In some implementations, the task description is a character string.

In some implementations, at least a second subset of the options in the set of options is based upon the task description but not the contents of the electronic message. In some implementations, the set of options are presented in an order determined in accordance with a weight assigned to each option in the set of options. The options in the first subset of the options are weighted so as to position the options in the first subset of the options more prominently than the options in the second subset of the options.

In some implementations, the identified task template includes one or more second task parameters. The method further includes determining values for the one or more second task parameters based on stored personal information. In some implementations, the stored personal information comprises a user profile. In some implementations, the stored personal information includes a home location. In some implementations, the stored personal information includes a current geographic location of the user. In some implementations, the stored personal information includes a log of previous task assistance selections by the user.

Another aspect of the present disclosure provides a computing device comprising one or more processors, memory, and one or more programs stored in the memory. The one or more programs are configured for execution by the one or more processors. The one or more programs comprise instructions for receiving, from a user, a task description corresponding to an electronic message. The one or more programs further comprise instructions for identifying, based on the task description, a task template from among a plurality of predefined task templates. The identified task template includes one or more first task parameters. The one or more programs further comprise instructions for determining values for the one or more first task parameters based on contents of the electronic message. The one or more programs further comprise instructions for presenting, to the user for user selection, a set of options for completing a task corresponding to the received task description. At least a first subset of the options in the set of options is based upon the one or more first task parameters.

Another aspect of the present disclosure provides a non-transitory computer readable storage medium storing one or more programs configured for execution by a computing device having one or more processors and memory. The one or more programs comprise instructions for receiving, from a user, a task description corresponding to an electronic message. The one or more programs further comprise instructions for identifying, based on the task description, a task template from among a plurality of predefined task templates. The identified task template includes one or more first task parameters. The one or more programs further comprise instructions for determining values for the one or more first task parameters based on contents of the electronic message. The one or more programs further comprise instructions for presenting, to the user for user selection, a set of options for completing a task corresponding to the received task description. At least a first subset of the options in the set of options is based upon the one or more first task parameters.

### BRIEF DESCRIPTION OF THE DRAWINGS

For a better understanding of the aforementioned implementations of the invention as well as additional implementations thereof, reference should be made to the Description of Implementations below, in conjunction with the following drawings in which like reference numerals refer to corresponding parts throughout the figures.

FIG. 1 illustrates a context in which some implementations operate.

FIG. 2 is a block diagram of a client computing device, according to some implementations.

FIG. 3 is a block diagram of a server, according to some implementations.

FIGS. 4A-4F illustrate aspects of user interfaces for task assistance, in accordance with some implementations.

FIGS. 5A-5C provide a flowchart of a process for task assistance, according to some implementations.

Reference will now be made in detail to implementations, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details.

### DESCRIPTION OF IMPLEMENTATIONS

According to the systems and methods described herein, users have the ability to add a task to an electronic message such as an email, which describes what action the user needs to take in relation to that email. When a user is typing in a task description for the task, the user is provided an auto-complete user interface. This systems and methods described herein further provide for auto-complete user interfaces that use biasing data to bias the auto-complete suggestions based on entities extracted from the email (e.g. contacts who are on the email thread, or entities mentioned in the email such as businesses, flights, account numbers, locations, etc.). This biasing data is used to increase the weight of those auto-complete suggestions that contain entities mentioned in the email (e.g., relative to those auto-complete suggestions that do not contain entities mentioned in the email).

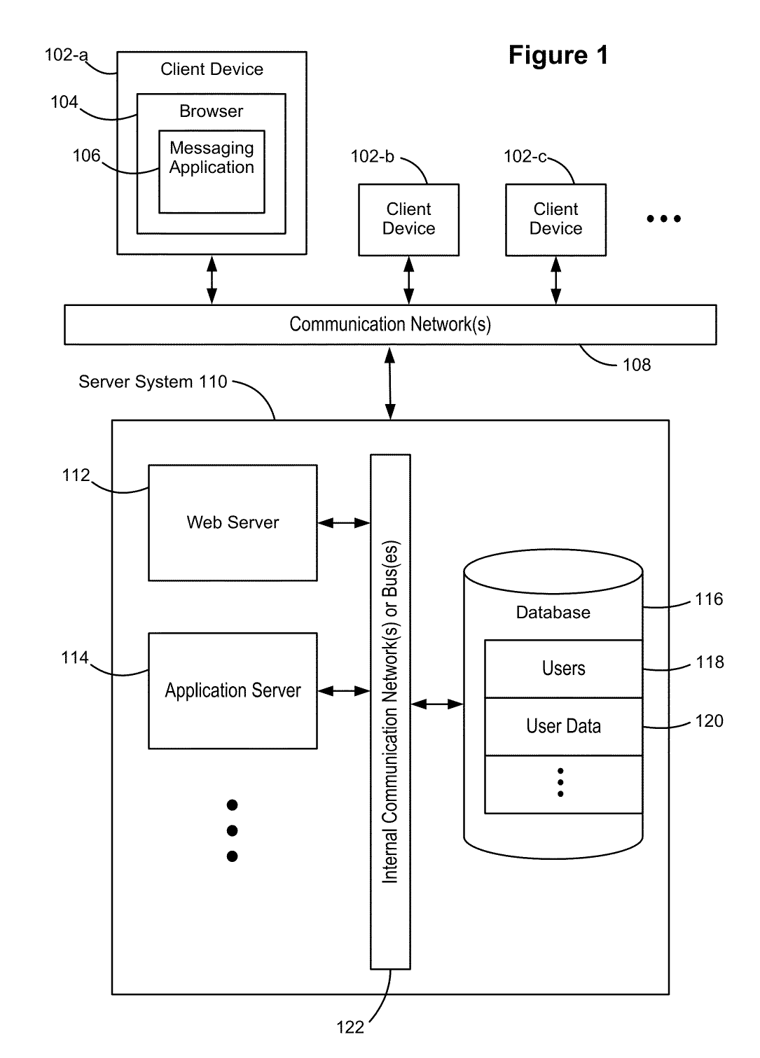

FIG. 1 is a block diagram that illustrates the major components of some implementations. The various client devices 102 (e.g., client devices 102-a, 102-b, and 102-c; also identified herein as computing devices) and servers 300 in a server system 110 communicate over one or more networks 108 (such as the Internet). A client device 102 may be a smart phone, a tablet computer, a laptop computer, a desktop computer, or other computing device that has access to a communication network 108 and can run a messaging application 106. In some implementations, the messaging application runs within a web browser 104.

In some implementations, the server system 110 consists of a single server 300. More commonly, the server system 110 includes a plurality of servers 300. In some implementations, the servers 300 are connected by an internal communication network of bus 122. The server system 110 includes one or more web servers 112, which receive requests from users (e.g., from client devices 102) and return appropriate information, resources, links, and so on. In some implementations, the server system 110 includes one or more application servers 114, which provide various applications, such as a messaging application 106. The server system 110 typically includes one or more databases 116, which store information such as web pages, a user list 118, and various user information 120 (e.g., user names and encrypted passwords, user preferences, and so on).

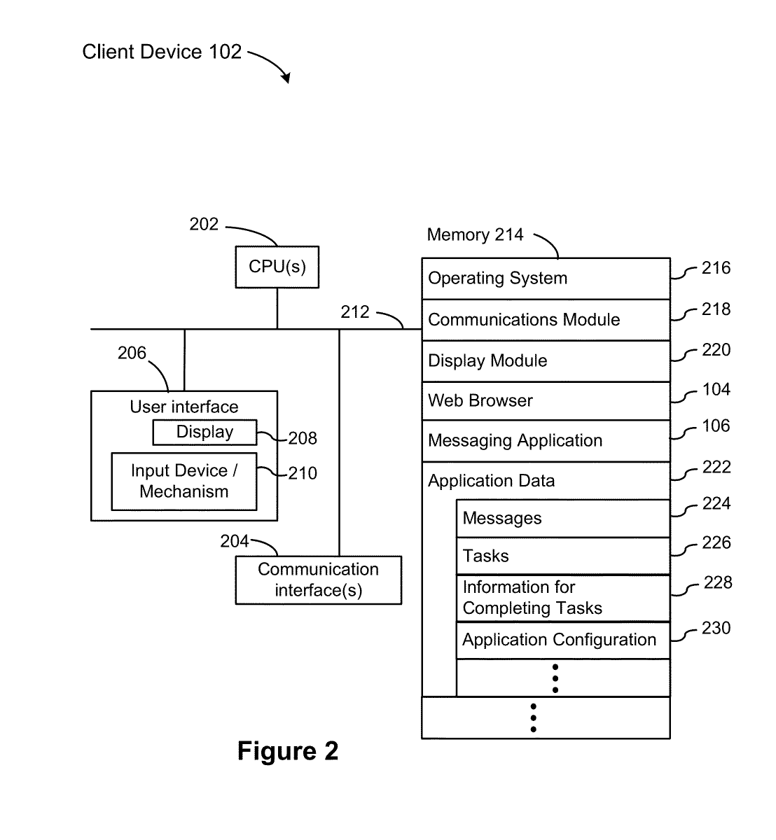

FIG. 2 is a block diagram illustrating a client device 102 that a user uses to access a messaging application 106. A client device is also referred to as a computing device, which may be a tablet computer, a laptop computer, a smart phone, a desktop computer, a PDA, or other computing device that can run a messaging application 106 and has access to a communication network 108. A client device 102 typically includes one or more processing units (CPUs) 202 for executing modules, programs, or instructions stored in memory 214 and thereby completing processing operations; one or more network or other communications interfaces 204; memory 214; and one or more communication buses 212 for interconnecting these components. The communication buses 212 may include circuitry (sometimes called a chipset) that interconnects and controls communications between system components. A client device 102 includes a user interface 206 comprising a display device 208 and one or more input devices or mechanisms 210. In some implementations, the input device/mechanism includes a keyboard and a mouse; in some implementations, the input device/mechanism includes a “soft” keyboard, which is displayed as needed on the display device 208, enabling a user to “press keys” that appear on the display 208.

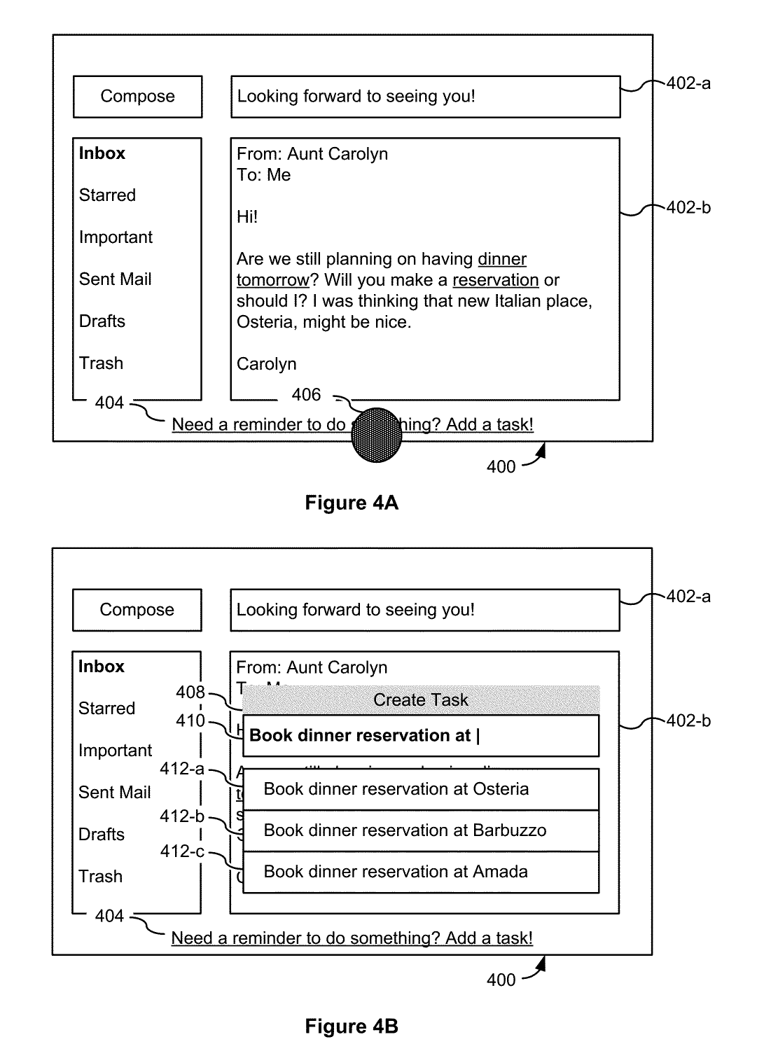

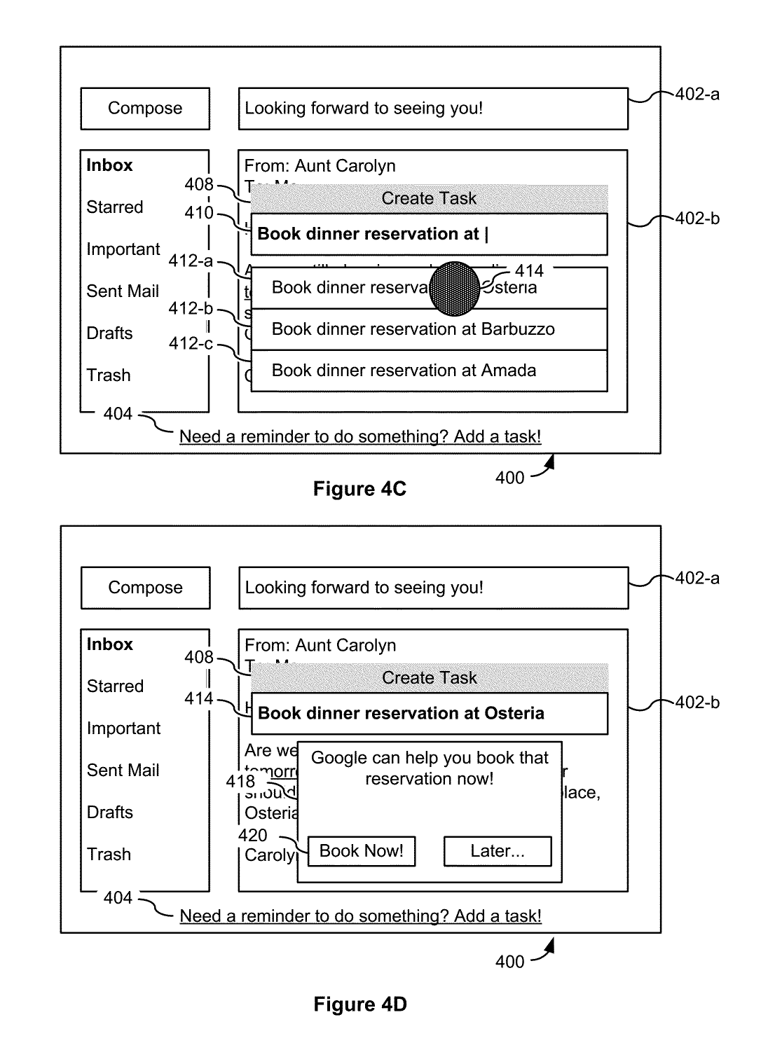

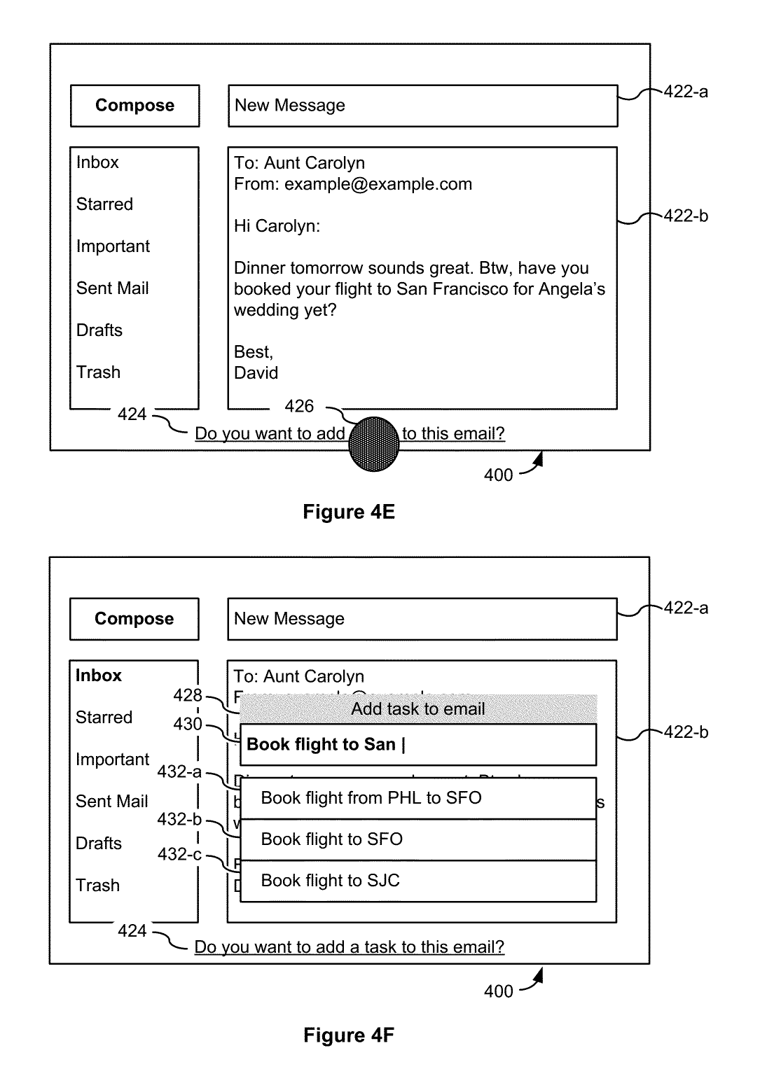

In some implementations, the memory 214 includes high-speed random access memory, such as DRAM, SRAM, DDR RAM or other random access solid state memory devices. In some implementations, memory 214 includes non-volatile memory, such as one or more magnetic disk storage devices, optical disk storage devices, flash memory devices, or other non-volatile solid state storage devices. In some implementations, the memory 214 includes one or more storage devices remotely located from the CPU(s) 202. The memory 214, or alternately the non-volatile memory device(s) within memory 214, comprises a non-transitory computer readable storage medium. In some implementations, the memory 214, or the computer readable storage medium of memory 214, stores the following programs, modules, and data structures, or a subset thereof:
an operating system 216, which includes procedures for handling various basic system services and for performing hardware dependent tasks;
a communications module 218, which is used for connecting the client device 102 to other computers and devices via the one or more communication network interfaces 204 (wired or wireless) and one or more communication networks 112, such as the Internet, other wide area networks, local area networks, metropolitan area networks, and so on;
a display module 220, which receives input from the one or more input devices 210, and generates user interface elements for display on the display device 208;
a web browser 104, which enables a user to communicate over a network 108 (such as the Internet) with remote computers or devices;
a messaging application 106, which enables the user to send and receive electronic messages. In some implementations, the messaging application is an email application. In some implementations, the messaging application is an instant messaging application. In some implementations, the messaging application 106 runs within the web browser 104 as illustrated in FIG. 1. In some implementations, the messaging application 106 runs independently of a web browser 104 (e.g., a desktop application). An example messaging application is illustrated below in FIGS. 4A-4F; and
application data 222, which is used by the messaging application 106. The application data comprises messages 224 (e.g., email messages or instant messages) as well as tasks 226, and information 228 for completing tasks. In some implementations a task 226 is associated with a message 224. In some implementations a task 226 is independent of all messages. The application data 222 may include configuration data 230, such as user preferences, user history, geographic information about the user, or the state of configuration options.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 214 may store a subset of the modules and data structures identified above. Furthermore, the memory 214 may store additional modules or data structures not described above.

Although FIG. 2 shows a client device 102, FIG. 2 is intended more as a functional description of the various features that may be present rather than as a structural schematic of the implementations described herein. In practice, and as recognized by those of ordinary skill in the art, items shown separately could be combined and some items could be separated.

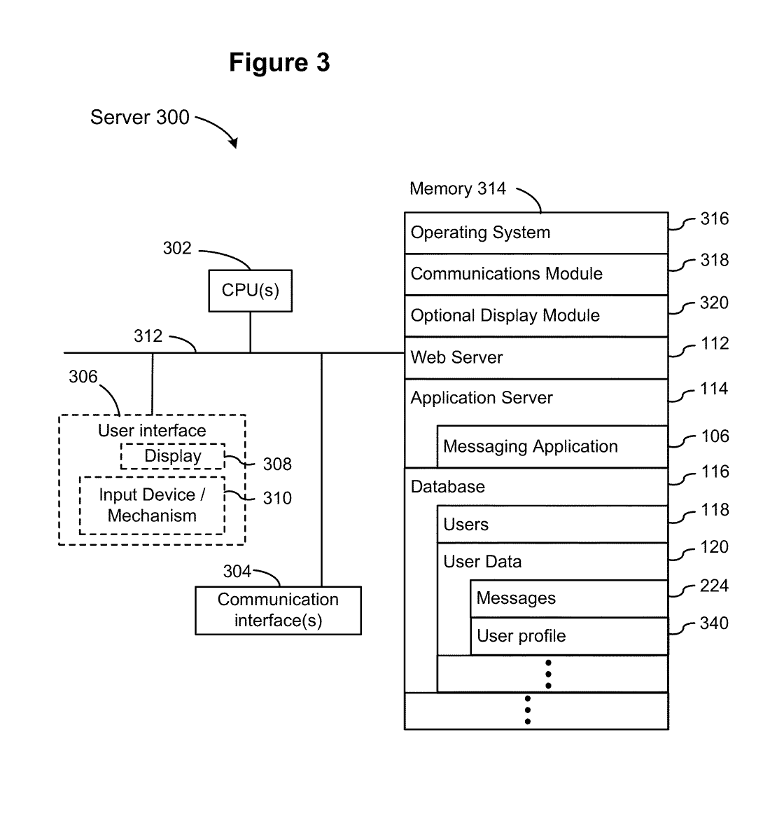

FIG. 3 is a block diagram illustrating a server 300 that may be used in a server system 110. A typical server system includes many individual servers 300, which may be hundreds or thousands. A server 300 typically includes one or more processing units (CPUs) 302 for executing modules, programs, or instructions stored in the memory 314 and thereby performing processing operations; one or more network or other communications interfaces 304; memory 314; and one or more communication buses 312 for interconnecting these components. The communication buses 312 may include circuitry (sometimes called a chipset) that interconnects and controls communications between system components. In some implementations, a server 300 includes a user interface 306, which may include a display device 308 and one or more input devices 310, such as a keyboard and a mouse.

In some implementations, the memory 314 includes high-speed random access memory, such as DRAM, SRAM, DDR RAM or other random access solid state memory devices. In some implementations, the memory 314 includes non-volatile memory, such as one or more magnetic disk storage devices, optical disk storage devices, flash memory devices, or other non-volatile solid state storage devices. In some implementations, the memory 314 includes one or more storage devices remotely located from the CPU(s) 302. The memory 314, or alternately the non-volatile memory device(s) within memory 314, comprises a non-transitory computer readable storage medium. In some implementations, the memory 314, or the computer readable storage medium of memory 314, stores the following programs, modules, and data structures, or a subset thereof:
an operating system 316, which includes procedures for handling various basic system services and for performing hardware dependent tasks;
a communications module 318, which is used for connecting the server 300 to other computers via the one or more communication network interfaces 304 (wired or wireless), an internal network or bus 122, or other communication networks 108, such as the Internet, other wide area networks, local area networks, metropolitan area networks, and so on;
an optional display module 320, which receives input from one or more input devices 310, and generates user interface elements for display on a display device 308;
one or more web servers 112, which receive requests from client device 102, and returns responsive web pages, resources, or links. In some implementations, each request is logged in the database 116;
one or more application servers 114, which provide various applications (such as an email or other messaging application) to client devices 102. In some instances, applications are provided as a set of web pages, which are delivered to client devices 102 and displayed in a web browser 104. The web pages are delivered as needed or requested. In some instances, an application is delivered to a client device 102 as a download, which is installed and run from the client device 102 outside of a web browser 104;
one or more databases 116, which store various data used by the modules or programs identified above. In some implementations, the database 116 includes a list of authorized users, which may include user names, encrypted passwords, and other relevant information about each user. The database 116 also stores user specific data 120 that is used by one or more of the applications provided by the application server. For example, some implementations store the electronic messages 224 for each user. As another example, some implementations store geographic information about a user.

Each of the above identified elements in FIG. 3 may be stored in one or more of the previously mentioned memory devices. Each executable program, module, or procedure corresponds to a set of instructions for performing a function described above. The above identified modules or programs (i.e., sets of instructions) need not be implemented as separate software programs, procedures or modules, and thus various subsets of these modules may be combined or otherwise re-arranged in various implementations. In some implementations, the memory 314 may store a subset of the modules and data structures identified above. Furthermore, the memory 314 may store additional modules or data structures not described above.

Although FIG. 3 illustrates a server 300, FIG. 3 is intended more as functional illustration of the various features that may be present in a set of one or more servers rather than as a structural schematic of the implementations described herein. In practice, and as recognized by those of ordinary skill in the art, items shown separately could be combined and some items could be separated. The actual number of servers used to implement these features, and how features are allocated among them, will vary from one implementation to another, and may depend in part on the amount of data traffic that the system must handle during peak usage periods as well as during average usage periods.

As illustrated in FIGS. 2 and 3, the functionality for a messaging application may be shared between a client device 102 and a server system 110. In some implementations, after the messaging application is installed on a client device 102, the majority of the subsequent processing occurs on the client device. In other implementations, the majority of the processing and data storage occurs at a server 300, and the client device 102 uses a web browser 104 to view and interact with the data (such an arrangement is sometimes referred to as “webmail”). One of skill in the art recognizes that various allocations of functionality between the client device 102 and the server system 110 are possible, and some implementations support multiple configurations (e.g., based on user selection).

FIGS. 4A-4F illustrate aspects of user interfaces for task assistance in accordance with some implementations. The user interfaces shown in FIGS. 4A-4F are displayed on a client device (e.g., client device 102, FIGS. 1 and 2).

FIG. 4A illustrates that a user interface is displayed in a messaging application 400 on a client device (e.g., a computing device). The user interface in messaging application 400 displays an electronic message 402 that includes a subject line (e.g., a portion of a header) 402-a and a message body 402-b. In this example, electronic message 402 is an email message. However, in accordance with a variety of implementations, the electronic messages described herein may be instant messages, text messages, etc. As shown in this example, the user is a recipient of electronic message 402. Electronic message 402 includes contents, which comprise at least message body 402-b and optionally further comprise subject line 402-a, attachments, and/or other metadata associated with electronic message 402. In addition, messaging application 400 displays, with electronic message 402, a prompt 404 (e.g., a user affordance, shown as a clickable underlined link) to add (e.g., enter) a task in response to receiving electronic message 402. When the user selects the prompt, through a user action 406 (e.g., a user-click of prompt 404), the client device initiates a process of adding a task that corresponds to electronic message 402.

FIG. 4B follows from FIG. 4A and is analogous to FIG. 4A but for the fact that FIG. 4B illustrates a user interface window 408 for adding a task that corresponds to electronic message 402. The user enters the task at least by entering a task description 410, which may be a partial task description subject to completion by auto-complete suggestions 412 (e.g., auto-complete suggestions 412-a; 412-b; and 412-c). Auto-complete suggestions 412 are sometimes referred to as a set of options for completing the task. The character “|” shown in task description 410 illustrates a cursor position and is intended to show that the user has not finished entering the task description, and thus the task description is a partial task description (e.g., the user has not submitted the task description by pressing the return key). At least one of the auto-complete suggestions—to wit, auto-complete suggestion 412-a—is based at least partially on contents of electronic message 402 (e.g., where the contents includes words in message body 402-a). In addition, auto-complete suggestions 412 are, as a whole, biased toward those auto-complete suggestions that are based on contents of electronic message 402. This is demonstrated in FIG. 4B by the fact that auto-complete suggestion 412-a, which is based on the contents of electronic message 402, is the first auto-complete suggestion in the list of auto-complete suggestions 412.

FIG. 4C follows from FIG. 4B and is analogous to FIG. 4B but for the fact that FIG. 4C illustrates user selection 414 of auto-complete suggestion 412-a, and thus illustrates that the user has selected a respective option of the set of options for completing the task. As used herein, the term “completing the task” is used in the sense of “auto-completion.” For example, the task is completed when the task description is updated in accordance with the auto-complete suggestion. In FIG. 4D, which follows from FIG. 4C, the task has been completed. In addition, FIG. 4C illustrates that, in some implementations, upon completion of the task, the user interface displays a user interface window 418 for performing the task. For example, in some implementations, user interface window 418 is configured to take the user to a website where the user can make a reservation at Osteria (the restaurant) when the user selects affordance 420 (“Book Now!”).

FIGS. 4E-4F illustrate another example of user interfaces for user task assistance, in accordance with some implementations. The user interface in messaging application 400 displays an electronic message 422 that includes a subject line (e.g., a portion of a header) 422-a and a message body 422-b. In this example, electronic message 402 is an email message. However, in accordance with a variety of implementations, the electronic messages described herein may be instant messages, text messages, etc. In this example, the user is using the user interface to compose electronic message 422 (e.g., the electronic message is to be sent by the user, in contrast to FIGS. 4A-4D in which the user is the recipient of electronic message 402). Moreover, the user interface allows the user to enter a task as an attachment to the email. To this end, the user interface includes an affordance 424 for adding a task as an attachment to the email.

When affordance 424 is selected, the user interface displays user interface window 428, shown in FIG. 4F, for entering a task (e.g., by entering a task description 430). As further shown in FIG. 4F, task description 430 is a partial task description that results in display of auto-complete suggestions 432 (e.g., auto-complete suggestions 432-a; 432-b; and 432-c). These auto-complete suggestions can be used to complete the task (e.g., update the task description accordingly and/or complete entry of the task into the messaging application). In some embodiments, when a task is completed, a record of the task is stored by the messaging application and/or a server system instructing the messaging application. Method 500 describes the details of how to determine and provide auto-complete suggestions 432. But for now it is sufficient to say that at least one of the auto-complete suggestions is based on the contents of electronic message 422. In particular, because electronic message 422 discusses flights to San Francisco, electronic message 422 has keywords that match a flight task template and a San Francisco value of a parameter of the flight template. The task template and parameter are used to produce auto-complete suggestions 432-a and 432-b, which are listed first (e.g., most prominently) because the auto-complete suggestions are biased toward auto-complete suggestions that are based on the contents of electronic message 422. In addition, in some implementations, personal information about the user is used to determine other parameters of the auto-complete suggestion. Such personal information is, in some implementations, stored in a user profile on a server system. For example, as shown in FIG. 4F, a user profile may indicate that the user lives in Philadelphia, resulting in auto-complete suggestion 432-a, which combines parameters obtained from electronic message 422 with parameters obtained from the user profile.

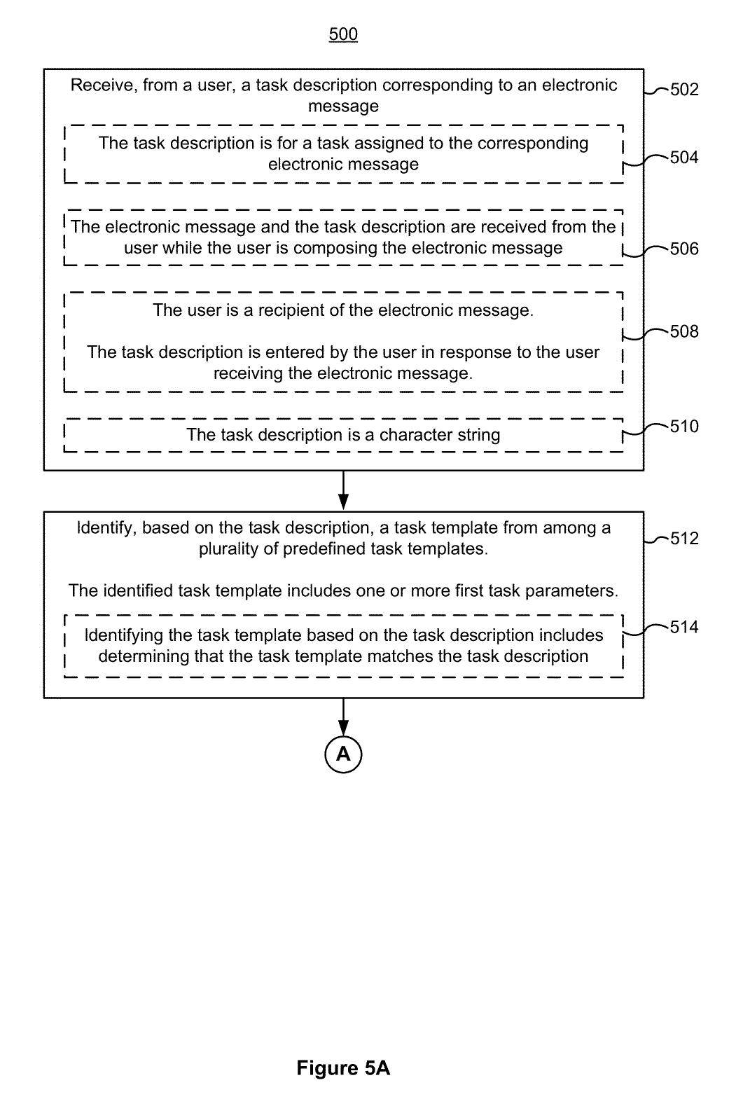

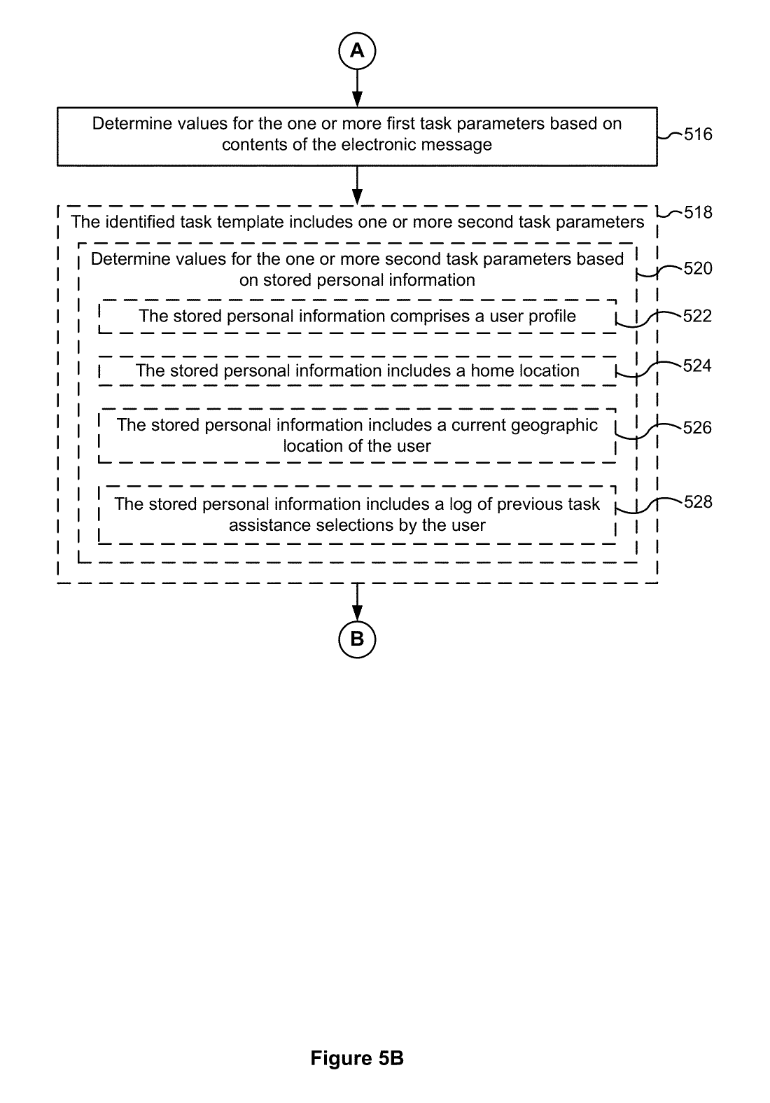

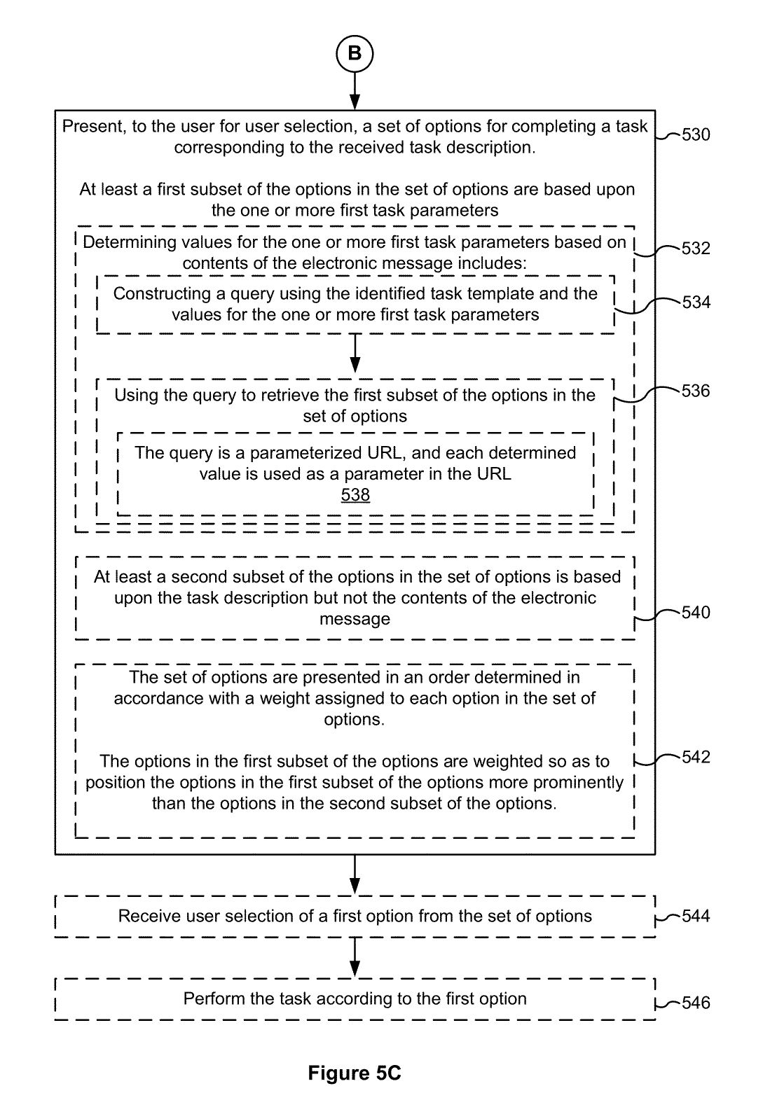

FIGS. 5A-5C provide a flowchart of a method 500, performed by a computing device, for providing task management. The method is performed at a computing device 102 and/or 110 having one or more processors and memory. The memory stores one or more programs configured for execution by the one or more processors. For ease of explanation, method 500 is described as being performed by a server system (e.g., server system 110, FIG. 1).

The server system receives (502), from a user, a task description corresponding to an electronic message. In some implementations, the task description is received in a messaging application on the user's client device (e.g., the messaging application may be a local application or a web application running through a web browser). In some implementations, the task description is a partial task description, meaning that the user has not yet entered (e.g., submitted) a full task description to the messaging application and/or to the server system (e.g., the user is not finished typing the task description). To that end, in some implementations, the messaging application sends, and the server system receives, partial task descriptions at predefined synchronization intervals (e.g., as the user is entering the task description), such as 0.1 seconds, or whenever the task description changes (e.g., whenever the user enters any character, or alternatively, a special character such as a space).

In some implementations, the task description is for a task. Such a task is sometimes called a reminder, as the messaging application will function to remind the user to perform the task. In some implementations, the task description is for a task that is (504) assigned to the corresponding electronic message. For example, in some implementations, the electronic message and the task description are received (506) from the user while the user is composing the electronic message. In some implementations, the task represents metadata or an attachment for the electronic message. In other words, information about the task (e.g., the what, when, how of the task etc.) is stored, retrieved, or sent as metadata together with the corresponding message. For example, FIGS. 4E-4F illustrate a scenario in which tasks can be added as “attachments” to an email. In some implementations, when a user receives an electronic message with a task assigned thereto (e.g., attached), the task is automatically (e.g., without user intervention) added to a task list for the user. The task list is provided in a separate window or folder of the messaging application's user interface.

Alternatively, in some implementations, a task description corresponds to an electronic message even when the task is not assigned to the electronic message. For example, as shown in FIGS. 4A-4D, in some implementations, the user is (508) a recipient of the electronic message. The task description is entered by the user in response to the user receiving the electronic message. In some, but not all, such implementations, the task is not assigned to the electronic message (as described above) but rather corresponds to the electronic message in at least two ways. The first way that the task corresponds to the electronic message is that the messaging application displays, concurrently with the electronic message, a prompt (e.g., a user affordance) to add a task. Thus, the user (who may be reminded by the electronic message that she needs to do something) is provided with an additional measure of convenience—the ability to add a task relating to the email is right at her fingertips. The second way that the task description corresponds to the electronic message is that the contents of the electronic message are used to provide auto-complete suggestions for the task, as described in the remainder of the description of method 500.

Thus, at least three examples are provided for when a task description corresponds to an electronic message: when the server system utilizes the contents of the electronic message to provide one or more auto-complete suggestions, when the electronic message is displayed with a prompt to enter the task description, and when the task description is for a task that is attached to the electronic message (e.g., as metadata).

In some implementations, the task description is (510) a character string. FIGS. 4A-4F illustrate examples in which task descriptions are entered by the user as character strings.

The server system identifies (512) based on the task description, a task template from among a plurality of predefined task templates. The identified task template includes one or more first task parameters. In some implementations, identifying the task template based on the task description includes determining (514) that the task template matches the task description. For example, certain terms in the task description are, in some implementations, indicators of the task template. For example, as shown in FIG. 4B, the term “dinner” is, in some implementations, an indicator (e.g., a sufficient indicator) of a task template for “dinner plans.” The task template for dinner plans includes optional task parameters such as a dinner location, a time for the dinner, a dish to bring, the total number of dinners, etc. A sufficient indicator for a respective task template means that the presence of such an indicator in the task description is sufficient to identify that the respective task template matches the task description. In some circumstances, the server system may identify several task templates based on the task description (e.g., when the task description includes sufficient indicators for multiple task templates).

In some implementations, the plurality of task templates includes task templates for making dinner plans, scheduling appointments, scheduling meetings, booking flights, and so on.

In some implementations, indicators are identifiable as corresponding to structured data, meaning that the server system can identify entities and/or objects corresponding to the indicator. Stated another way, in some implementations, indicators are keywords corresponding to structured data. Names of months, names of cities, dates and times, relative dates (e.g., “tomorrow”) are all examples of indicators that can be related to a well-defined entity or object. For example, the term “tomorrow,” when found in a task description, can be used in conjunction with the current date (e.g., stored on the server system) to determine a value for a date task parameter for the dinner task template (see operation 516).

In some implementations, the server system identifies the task template based on contents of the electronic message. For example, in some implementations, the server system offers auto-complete suggestions even before receiving a task description. Instead, in some implementations, the auto-complete suggestions (e.g., starting with identification of the task template) are based solely on the contents of the electronic message. In some implementations, those auto-complete suggestions are updated and/or replaced based on the task description in accordance with method 500. In some implementations, the task template is identified based on a combination of the task description and the contents of the electronic message.

The server system determines (516) values for the one or more first task parameters based on contents of the electronic message. In some implementations, the contents of the electronic message include the body of the electronic message (e.g., an email body). In some implementations, the contents of the electronic message include attachments to the electronic message, a header of the electronic message, and/or metadata associated with the electronic message. In some implementations, the values are well-defined, identifiable, objects and/entities (e.g., the values are obtained from structured data). Consider, as an example, a task template for dinner plans that includes a location task parameter. The value of the location task parameter for dinner plans could be somebody's home (e.g., “My house”), a restaurant, a public park, etc. In some implementations, the server system stores a list of restaurants and, optionally, information about those restaurants (e.g., hours of operation, food-type, and/or price range). Take, as the example shown in FIG. 4B, a list of restaurants that includes at least three restaurants: Osteria, Barbuzzo, and Amada. In this example, the server system analyzes the contents of the electronic message and determines that Osteria corresponds to structured data; to wit, it corresponds to an object for Osteria, the restaurant in the restaurant list. Thus, the server determines that a value for the location task parameter for dinner plans is restaurant object Osteria. In some circumstances, there may be multiple restaurants named “Osteria” and the server system uses stored personal information, described below, to disambiguate which Osteria is likely meant.

In some implementations, the identified task template (518) includes one or more second task parameters. In such implementations, the server system determines (520) values for the one or more second task parameters based on stored personal information. In some implementations, the stored personal information comprises (522) a user profile. In some implementations, the stored personal information includes (524) a home location. In some implementations, the stored personal information includes (526) a current geographic location of the user. Consider an example of a task description that begins with the character string “Book flight.” Such a task description may be sufficient to identify a flight booking task template, which includes task parameters such as “Departing Airport” (e.g., a respective second task parameter) and “Destination Airport” (e.g., a respective first task parameter) among others. When the contents of the message body includes the words “to Atlanta,” in some implementations, the server system determines a value of ATL (i.e., the federal aviation administration (FAA) airport code for the Hartsfield-Jackson Atlanta International Airport) for the respective first task parameter, and uses a home location stored in the user's profile to determine that the user is nearest to PHL (i.e., the FAA airport code for the Philadelphia International Airport) and, furthermore, to determine that a value of PHL is appropriate for the respective second task parameter.

In some implementations, the stored personal information includes (528) a log of previous task assistance selections by the user. For example, in some implementations, the server system uses a log of previous flights booked by the user to determine that PHL is the user's most common departing airport, and thus uses PHL for the value of the respective second task parameter.

The server system presents (530), to the user for user selection, a set of options for completing a task corresponding to the received task description. Stated another way, the system presents auto-complete suggestions to the user for completing the task. At least a first subset of the options in the set of options is based upon the one or more first task parameters. In some implementations, the first subset of options includes at least one of the first task parameters. In some implementations, the set of options comprises a plurality of options (e.g., two or more, three or more, etc.). In some implementations, the first subset of options includes information corresponding to the first task parameters. Stated another way, at least some of the auto-complete suggestions are based on the contents of the electronic message, which is used to determine values for the one or more first task parameters as described above. As used herein, “completing” a task is used in the sense of “auto-complete.” For example, in some implementations, completing the task means completing the process of recording (e.g., completely recording) the task within the messaging application, e.g., so that the messaging application can provide reminders. In some implementations, completing the task includes storing a unique record in memory with information about the task. In some implementations, completing the task means updating the task description in accordance with one of the set of options. In contrast, performing the task means the actual doing of what is required by the task (e.g., the act of booking a flight is performance of a task).

In some implementations, determining values for the one or more first task parameters based on contents of the electronic message includes (532): Constructing (534) a query using the identified task template and the values for the one or more first task parameters and using (536) the query to retrieve the first subset of the options in the set of options. In some implementations, the query is (538) a parameterized universal resource locator (URL) and each determined value is used as a parameter in the URL.

In some implementations, at least a second subset of the options in the set of options is (540) based upon the task description but not the contents of the electronic message. In some implementations, the set of options are presented (542) in an order determined in accordance with a weight assigned to each option in the set of options. The options in the first subset of the options are weighted so as to position the options in the first subset of the options more prominently (e.g., higher in the order) than the options in the second subset of the options. Stated another way, the server system choice of which auto-complete suggestions to display is based on a weight associated with each potential auto-complete suggestion (e.g., the server system chooses the three most highly weighted auto-complete suggestion to display). Further, auto-complete suggestions that are based on the contents of the electronic message are up-weighted such that the set of auto-complete suggestions is biased toward those auto-complete suggestions that are based on the contents of the electronic message. More simply put: the presentation of auto-complete suggestions is biased toward auto-complete suggestions that are based on contents of the electronic message. In some implementations, auto-complete suggestions are weighted in accordance with a variety of factors and auto-complete suggestions that are based on electronic message contents are given a predetermined bias (e.g., a fixed offset to their respective weights). Other factors affecting the weight of auto-complete suggestions may include proximity of the user to entities within the auto-complete suggestions and/or factors based on other stored personal information, as described above. For example, when displaying auto-complete suggestions for airports, in some implementations, the auto-complete suggestions are weighted based on the “Departing Airports” proximity to the user.

In some implementations, the server system receives (544) user selection of a first option from the set of options and completes (546) the task according to the first option. In some implementations, the server system sends instructions to the messaging application prompting the user to enter further details about the task.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations described herein were chosen and described in order to best explain the principles of the invention and its practical applications, to thereby enable others skilled in the art to best utilize the invention and various implementations with various modifications as are suited to the particular use contemplated.

What is claimed is:

1. A method of user task assistance, comprising:
at a computing device having one or more processors and memory storing one or more programs configured for execution by the one or more processors:
receiving, from a user, a task description corresponding to an electronic message;
identifying, based on the task description, a task template from among a plurality of predefined task templates, wherein the identified task template includes one or more first task parameters;
determining values for the one or more first task parameters based on contents of the electronic message; and
presenting, to the user for user selection, a set of options for completing a task corresponding to the received task description, wherein at least a first subset of the options in the set of options are based upon the one or more first task parameters.

2. The method of claim 1, wherein:
determining values for the one or more first task parameters based on contents of the electronic message includes:
constructing a query using the identified task template and the values for the one or more first task parameters; and
using the query to retrieve the first subset of the options in the set of options.

3. The method of claim 2, wherein the query is a parameterized universal resource locator (URL), and each determined value is used as a parameter in the URL.

4. The method of claim 1, wherein identifying the task template based on the task description includes determining that the task template matches the task description.

5. The method of claim 1, wherein the task description is for a task that is assigned to the corresponding electronic message.

6. The method of claim 1, wherein the electronic message and the task description are received from the user while the user is composing the electronic message.

7. The method of claim 1, wherein:
the user is a recipient of the electronic message; and
the task description is entered by the user in response to the user receiving the electronic message.

8. The method of claim 1, further comprising:
receiving user selection of a first option from the set of options; and
completing the task according to the first option.

9. The method of claim 1, wherein the task description is a character string.

10. The method of claim 1, wherein at least a second subset of the options in the set of options are based upon the task description independent of the contents of the electronic message.

11. The method of claim 10, wherein:
the set of options are presented in an order determined in accordance with a weight assigned to each option in the set of options; and
the options in the first subset of the options are weighted so as to position the options in the first subset of the options more prominently than the options in the second subset of the options.

12. The method of claim 1, wherein:
the identified task template includes one or more second task parameters; and
the method further includes:
determining values for the one or more second task parameters based on stored personal information.

13. The method of claim 12, wherein the stored personal information comprises a user profile.

14. The method of claim 1, wherein the stored personal information includes a home location.

15. The method of claim 1, wherein the stored personal information includes a current geographic location of the user.

16. The method of claim 1, wherein the stored personal information includes a log of previous task assistance selections by the user.

17. A computing device, comprising:
one or more processors;
memory; and
one or more programs stored in the memory configured for execution by the one or more processors, the one or more programs comprising instructions for:
receiving, from a user, a task description corresponding to an electronic message;
identifying, based on the task description, a task template from among a plurality of predefined task templates, wherein the identified task template includes one or more first task parameters;
determining values for the one or more first task parameters based on contents of the electronic message; and
presenting, to the user for user selection, a set of options for completing a task corresponding to the received task description, wherein at least a first subset of the options in the set of options are based upon the one or more first task parameters.

18. The computing device of claim 17, wherein at least a second subset of the options in the set of options are based upon the task description but not the contents of the electronic message.

19. The computer device of claim 18, wherein:
the set of options are presented in an order determined in accordance with a weight assigned to each option in the set of options; and
the options in the first subset of the options are weighted so as to position the options in the first subset of the options more prominently than the options in the second subset of the options.

20. A non-transitory computer readable storage medium storing one or more programs configured for execution by a computing device having one or more processors and memory, the one or more programs comprising instructions for:
receiving, from a user, a task description corresponding to an electronic message;
identifying, based on the task description, a task template from among a plurality of predefined task templates, wherein the identified task template includes one or more first task parameters;
determining values for the one or more first task parameters based on contents of the electronic message; and
presenting, to the user for user selection, a set of options for completing a task corresponding to the received task description, wherein at least a first subset of the options in the set of options are based upon the one or more first task parameters.
